(19) United States
(12) Patent Application Publication
(10) Pub. No.: US 2017/0032559 A1
(43) Pub. Date: Feb. 2, 2017

(54) Simulated Transparent Device

(71) Applicant: MediaTek Inc., Hsinchu City (TW)

(72) Inventors: Ping Chao, Taipei City (TW); Chih-Kai Chang, Taichung City (TW); Tsu-Ming Liu, Hsinchu City (TW); Chih-Ming Wang, Hsinchu County (TW)

(21) Appl. No.: 15/293,470

(22) Filed: Oct. 14, 2016

Related U.S. Application Data
(60) Provisional application No. 62/242,434, filed on Oct. 16, 2015.

(51) Int. Cl. G06T 11/60; G06K 9/00; H04N 5/247

(52) U.S. Cl. CPC G06T 11/60; H04N 5/247; G06K 9/00228; G06T 2210/22; G06F 3/04817

(57) ABSTRACT

Methods and apparatuses pertaining to a simulated transparent device may involve capturing a first image of a surrounding of the display with a first camera, as well as capturing a second image of the user with a second camera. The methods and apparatuses may further involve constructing a see-through window of the first image, wherein, when presented on the display, the see-through window substantially matches the surrounding and creates a visual effect with which at least a portion of the display is substantially transparent to the user. The methods and apparatuses may further involve presenting the see-through window on the display. The constructing of the see-through window may involve computing a set of cropping parameters, a set of deforming parameters, or a combination of both, based on a spatial relationship among the surrounding, the display, and the user.

### CROSS REFERENCE TO RELATED PATENT APPLICATION(S)

The present disclosure claims the priority benefit of U.S. patent application Ser. No. 62/242,434, filed on 16 Oct. 2015, which is incorporated by reference in its entirety.

### TECHNICAL FIELD

The present disclosure is generally related to visual display technologies and, more particularly, to realization of a simulated transparent display for a device, which could be a portable device or a stationary device.

### BACKGROUND

Unless otherwise indicated herein, approaches described in this section are not prior art to the claims listed below and are not admitted to be prior art by inclusion in this section.

Electronic visual display devices of various sizes and kinds have been prevailing in modern living. For example, information displays, interactive touch screens, monitors, televisions, bulletin boards, public signage, indoor and outdoor commercial displays, and the like, have been widely used in stores, work places, train stations, airports, and other public areas. In addition, most personal electronic devices, such as mobile phones, tablet computers, laptop computers, and the like, usually include one or more displays integrated therein. While showing an intended visual content (e.g., text(s), graphic(s), image(s), picture(s), and/or video(s)), however, each of these displays is opaque in nature. That is, while being able to see the intended visual content shown on the display, a user of the display is not able, even partially, to “see through” the display and see the object(s) and surrounding behind the display. This opaque nature of existing displays inevitably excludes realization of applications that could be otherwise implemented with a transparent or semi-transparent display.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose novel schemes pertaining to a simulated transparency for implementing a simulated transparent or semi-transparent display with an opaque display.

In one aspect, an apparatus may include a memory configured to store one or more sets of instructions. The apparatus may also include a processor coupled to execute the one or more sets of instructions in the memory. Upon executing the one or more sets of instructions, the processor may be configured to receive data of an image of a surrounding of a display. Moreover, the processor may also be configured to construct a see-through window of the image. When presented on the display, the see-through window may substantially match the surrounding and thus create a visual effect with which at least a portion of the display is substantially transparent to a user. Furthermore, the processor may further be configured to present the see-through window on the display.

In another aspect, a method of simulating a display to be substantially transparent to a user may involve capturing a first image of a surrounding of the display with a first camera, the first image having a first viewing angle. The method may also involve capturing a second image of the user with a second camera, with the second image having a second viewing angle. The method may also involve constructing a see-through window of the first image. When presented on the display, the see-through window may substantially match the surrounding and thus create a visual effect with which at least a portion of the display is substantially transparent to the user.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario for using a transparency-simulating apparatus in accordance with an implementation of the present disclosure.

FIG. 2 is a diagram of an example surrounding in which a transparency-simulating apparatus is used in accordance with an implementation of the present disclosure.

FIG. 3 is a diagram of an example scenario where a display is operated in a non-transparent mode in accordance with an implementation of the present disclosure.

FIG. 4 is a diagram of an example scenario where a display is operated in a transparent mode in accordance with an implementation of the present disclosure.

FIG. 5 is a diagram of another example scenario where a display is operated in a transparent mode in accordance with an implementation of the present disclosure.

FIG. 6 is a diagram of an example construction of a see-through window in accordance with an implementation of the present disclosure.

FIG. 7 is a diagram depicting a viewing angle of an image in accordance with an implementation of the present disclosure.

Each of FIGS. 8-10 is a diagram illustrating a construction of a see-through window in accordance with an implementation of the present disclosure.

FIG. 11 is a diagram illustrating an image of a user in accordance with an implementation of the present disclosure.

Each of FIGS. 12-14 is a diagram illustrating a construction of a see-through window in accordance with an implementation of the present disclosure.

FIG. 15 is a simplified block diagram of an example apparatus in accordance with an implementation of the present disclosure.

FIG. 16 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

With a transparent or semi-transparent display in accordance with the present application, a viewer or user of the display would be able to see the object(s) and surrounding that may be partially or completely blocked by an otherwise opaque display. This feature is especially useful for portable devices such as mobile phones and tablet devices. For example, with a transparent or semi-transparent display of a mobile device, a user would, while using the mobile device and simultaneously walking down a street, be able to see whether there is an obstacle in the street that he or she may not be able to see (and might otherwise trip or stumble over), thereby enhancing safety of the user when using the mobile device while moving. In addition, the transparent or semi-transparent display of the mobile device in accordance with the present disclosure would create a unique user experience that is otherwise not attainable with an opaque display, thereby enhancing the user experience.

Under the proposed schemes, an opaque display may be simulated to serve as a transparent or semi-transparent display to a user. Through a computation performed by a special-purpose processor, a see-through window may be constructed by an apparatus using the processor and having an otherwise opaque display such that, when displayed on the opaque display and seen from a viewpoint of the user, the see-through window would substantially match a surrounding of the display, thereby creating a visual effect with which at least a portion of the display appears to be transparent to the user. Moreover, under the proposed schemes, by adaptively and continually updating the see-through window, the display would appear to be transparent even if there is a relative movement between any two of the user, the display, and the surrounding. Furthermore, under the proposed schemes, a transparency setting may be determined for the see-through window to simulate a semi-transparent display that may blend the see-through window with one or more other displaying objects such as one or more graphical user interface (GUI) objects and/or one or more augmented reality (AR) objects.

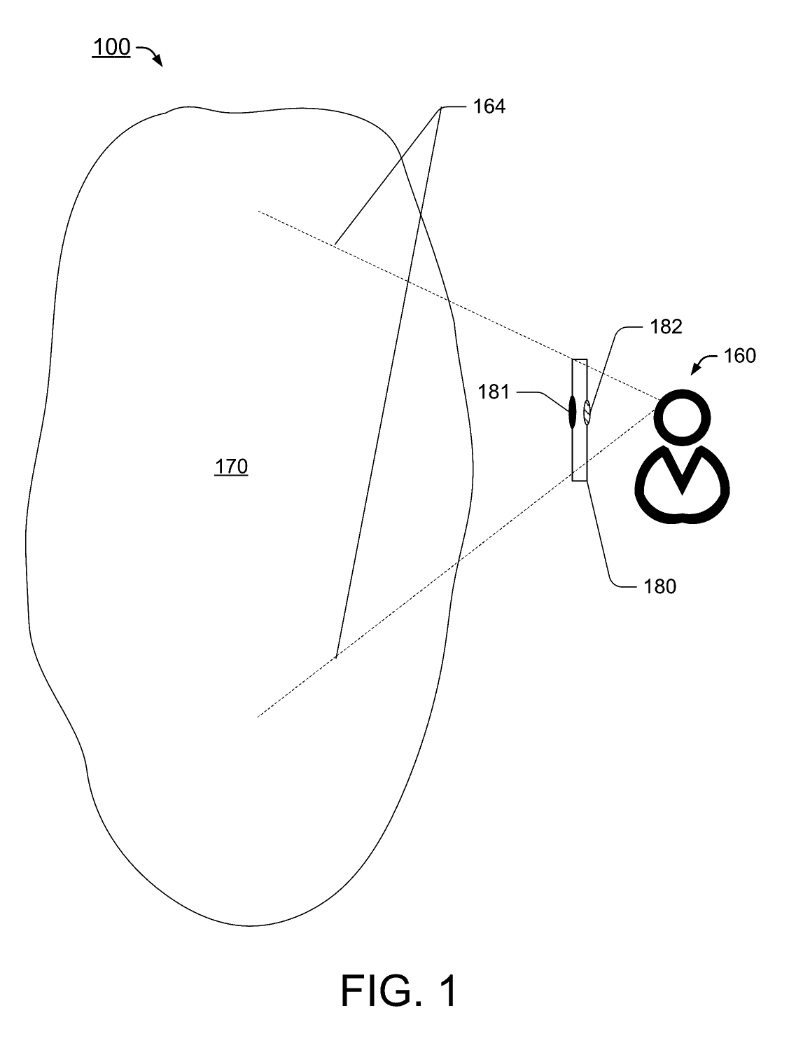

FIG. 1 illustrates an example scenario 100 for a user 160 to use a transparency-simulating apparatus in accordance with an implementation of the present disclosure. In scenario 100, a display 180 is disposed in front of user 160, with a background or surrounding 170 laying further in the back of display 180. That is, user 160 may have his or her view 164 land on display 180 first and then further extend beyond display 180 to reach surrounding 170. A transparency-simulating apparatus, which in some embodiments may be integrated with display 180, may create a simulated transparency for display 180 as being viewed by user 160. A fist camera, or main camera, 181 may face surrounding 170 to capture one or more images of surrounding 170. A second camera, or front camera, 182 may face user 160 and capture one or more images of user 160.

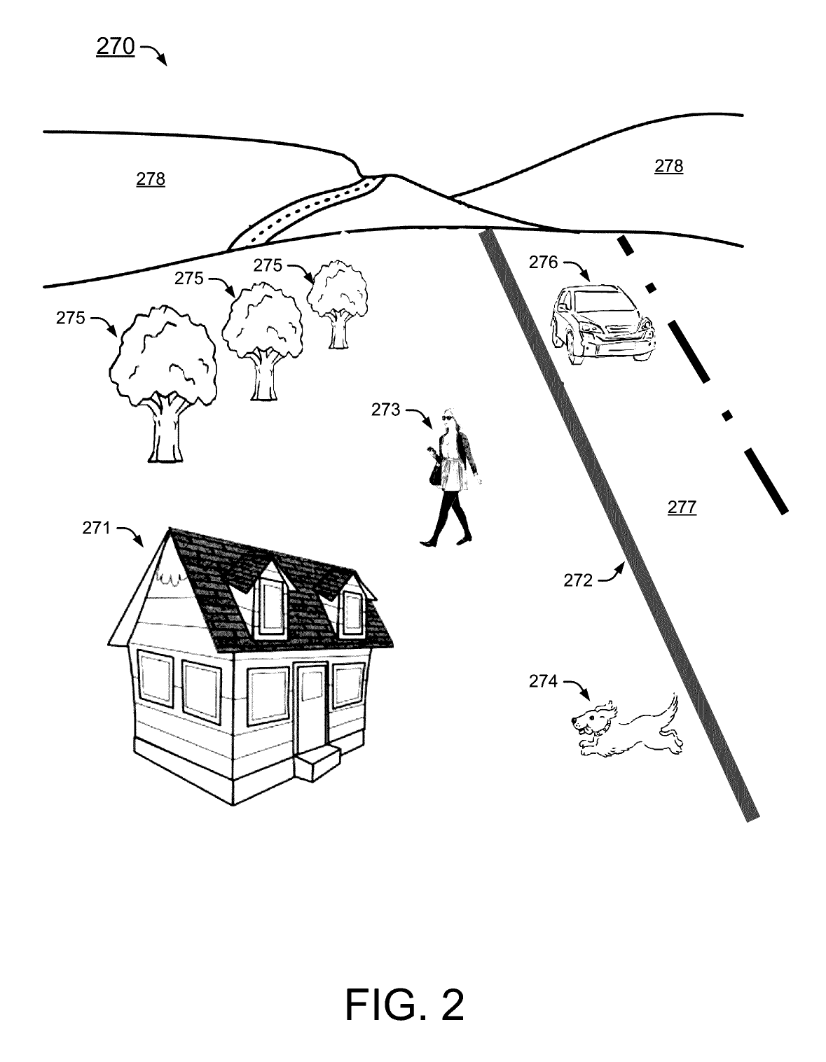

FIG. 2 illustrates an example surrounding 270 in which a transparency-simulating apparatus is used in accordance with an implementation of the present disclosure. Surrounding 270 may have various stationary and/or moving objects therein, such as house 271, curbside 272 of a road 277, pedestrian 273, dog 274, trees 275, car 276 moving in road 277, and hills 278, as shown in FIG. 2. Surrounding 170 of FIG. 1 may include at least a part of surrounding 270 of FIG. 2.

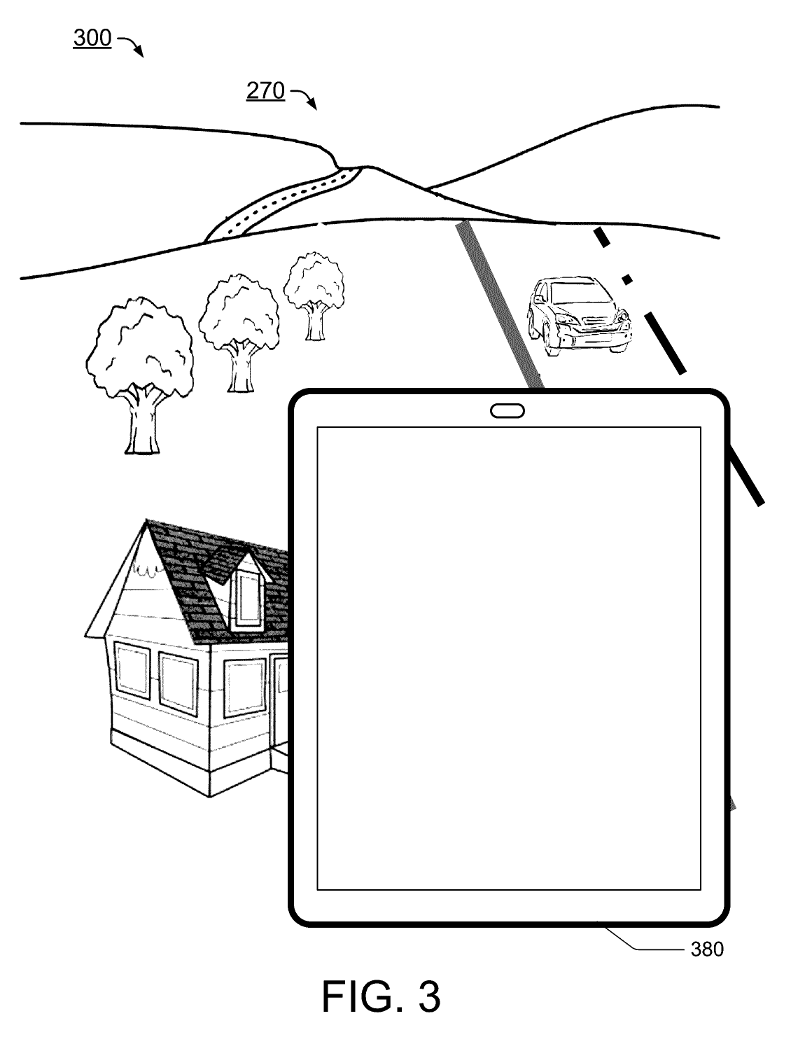

FIG. 3 illustrates an example scenario 300 in which a display 380 is operated in a non-transparent mode in accordance with an implementation of the present disclosure. In scenario 300, display 380 is disposed between a user (not shown in FIG. 3) and surrounding 270 of FIG. 2. Since display 380 is being operated in the non-transparent mode, display 380 is opaque to the user, and various objects in surrounding 270 may be blocked by display 380 from the user's view. For example, pedestrian 273, dog 274, a portion of house 271, a portion of road 277, as well as a section of curbside 272 are blocked by display 380 and thus not visible to the user.

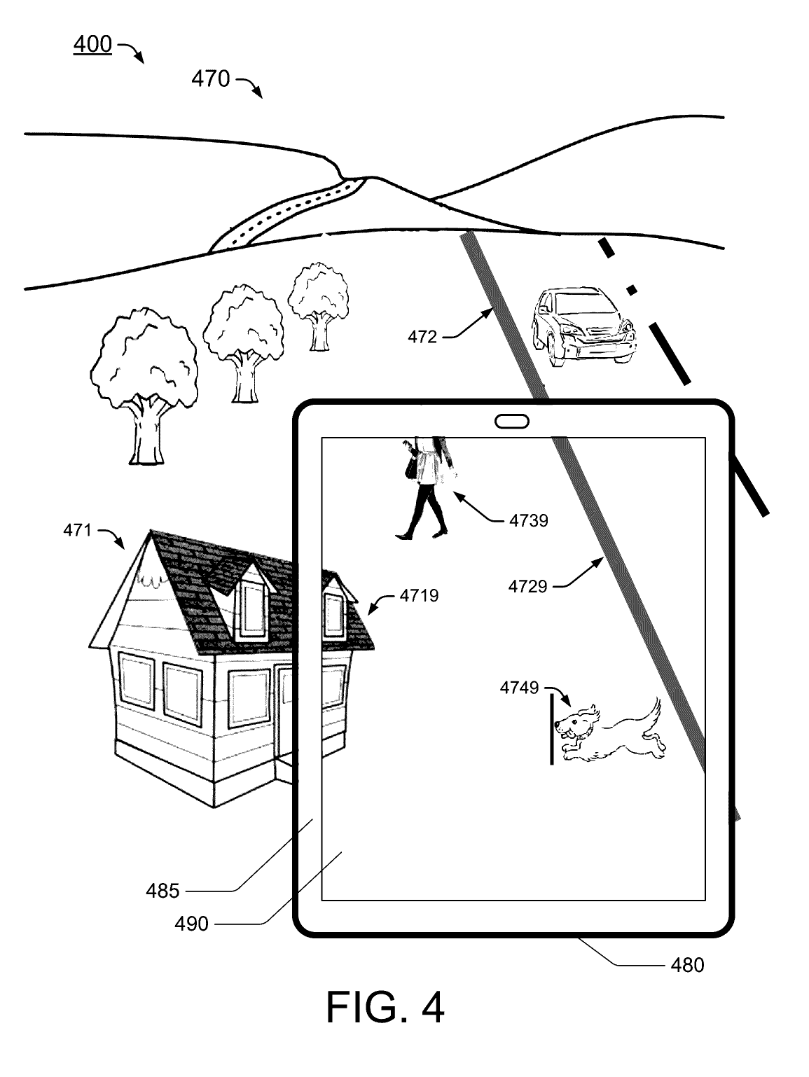

FIG. 4 illustrates an example scenario 400 in which a display 480 is operated in a transparent mode in accordance with an implementation of the present disclosure. In scenario 400, display 480 is disposed between a user (not shown in FIG. 4) and surrounding 470, which is very similar to surrounding 270 of FIG. 2. Since display 480 is being operated in the transparent mode, a see-through window 490 is presented on display 480 to create a visual effect to the user such that at least a portion of display 480 (e.g., the portion corresponding to see-through window 490) appears transparent to the user. Specifically, when presented on display 480, see-through window 490 closely matches a portion of surrounding 470 such that display 480 appears to be transparent to the user. For example, without see-through window 490, a part of house 471 and a section of curbside 472 would have been obstructed from the view of the user as they are blocked by display 480 from being seen directly by the user. However, see-through window 490 includes a partial image 4719 of house 471. From the user's point of view, partial image 4719 of house 471 substantially matches with actual house 471 at an edge of see-through window 490, and a visual effect is thereby created such that house 471 seems not completely blocked by display 480. Likewise, see-through window 490 also includes a partial image 4729 of curbside 472. From the user's point of view, partial image 4729 of curbside 472 substantially matches with actual curbside 472 at an edge of see-through window 490, and a visual effect is thereby created such that curbside 472 seems not completely blocked by display 480. In addition, see-through window 490 further includes an images 4739 of a pedestrian and an images 4749 of a dog, both blocked by display 480 from being seen directly by the user. Images 4739 and 4749 also create a visual effect as if the user could “see through” the opaque display 480 and see the pedestrian and the dog. This seemingly visual effect of transparency is particularly effective if display 480 has a frame 485 that is relatively thin compared to an actual displaying area (which essentially has a size of see-through window 490) of display 480. A thinner frame 485 further enhances the matching between see-through window 490 and the portion of surrounding 470 that is obstructed by display 480.

In some embodiments, at least a part of the see-through window may be blurred to create a visual effect that mimics a single depth of focus of human eyes. For example, see-through window 490 includes a partial image 4739 of a pedestrian and an image 4749 of a dog. When presented on display 480, see-through window 490 may have an area around or encompassing partial image 4739 (the pedestrian) blurred out to some extent such that, when presented along with image 4749 (the dog), which is not blurred out, a visual effect is created that mimics a single depth of focus of human eyes, with the focus on the fog rather than on the pedestrian.

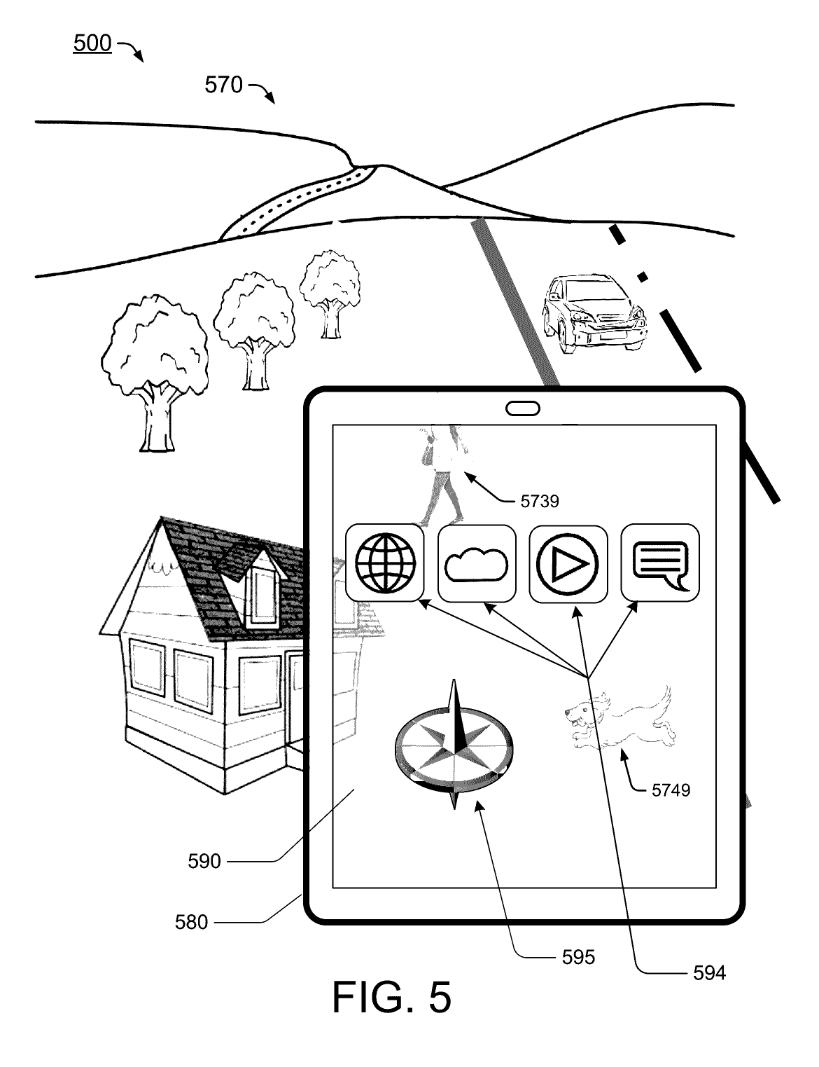

In some embodiments, the see-through window may include one or more other displaying objects which do not have counterparts in the actual surrounding. Such one or more other objects may include one or more icons, one or more buttons, one or more graphical user interface (GUI) objects, and/or one or more augmented reality (AR) objects. To illustrate this feature, FIG. 5 depicts an example scenario 500 in which a display 580 is operated in a transparent mode in accordance with an implementation of the present disclosure. In scenario 500, display 580 is disposed between a user (not shown in FIG. 5) and surrounding 570, which is similar to surrounding 270 of FIG. 2. A see-through window 590 is presented on display 580 to create a visual effect of transparency. In addition to images 5739 and 5749, see-through window 590 further includes software touch buttons 594 and an AR object 595. Specifically, see-through window 590 has touch buttons 594 and an AR object 595 blended with a see-through window that is similar to see-through window 490 of FIG. 4. This feature enables the user to operate software applications, or apps, via display 580, which may be a touch screen, while display 580 is operated in the transparent mode. In some embodiments, when see-through window 590 is presented on display 580, a transparency setting of see-through window 590 may be determined and/or adjusted, either by user's preference or by an algorithm. In some embodiments, the transparency setting may be adjusted or determined so as to enhance presentation quality or user experience regarding see-through window 590, especially when see-through window 590 is presented along with software touch buttons 594 and/or AR object 595. In some embodiments, the transparency setting may apply to a part, but not all, of the see-through window. For example, as shown in FIG. 5, the transparency setting is not applied to software touch buttons 594 or AR object 595, but is applied to the rest of see-through window 590, including images 5739 and 5749.

In some embodiments, a color temperature setting of see-through window 590 may be determined and/or adjusted, and see-through window 590 may be presented on display 580 with the color temperature setting. In some embodiments, the color temperature setting may be adjusted or determined such that see-through window 590 may have a color temperature that is closer to that of surrounding 570, thereby enhancing the matching between see-through window 590 and surrounding 570.

In some embodiments, even when the surrounding is changing, the user is moving to a different location, and/or the display is being moved to a different location, the above schemes of construction and presentation of the see-through window may be adaptively and continually repeated so that the display stays substantially transparent to the user in response to a relative movement of any of the user, the display, and the surrounding with respect to any other thereof.

### Construction of See-Through Window

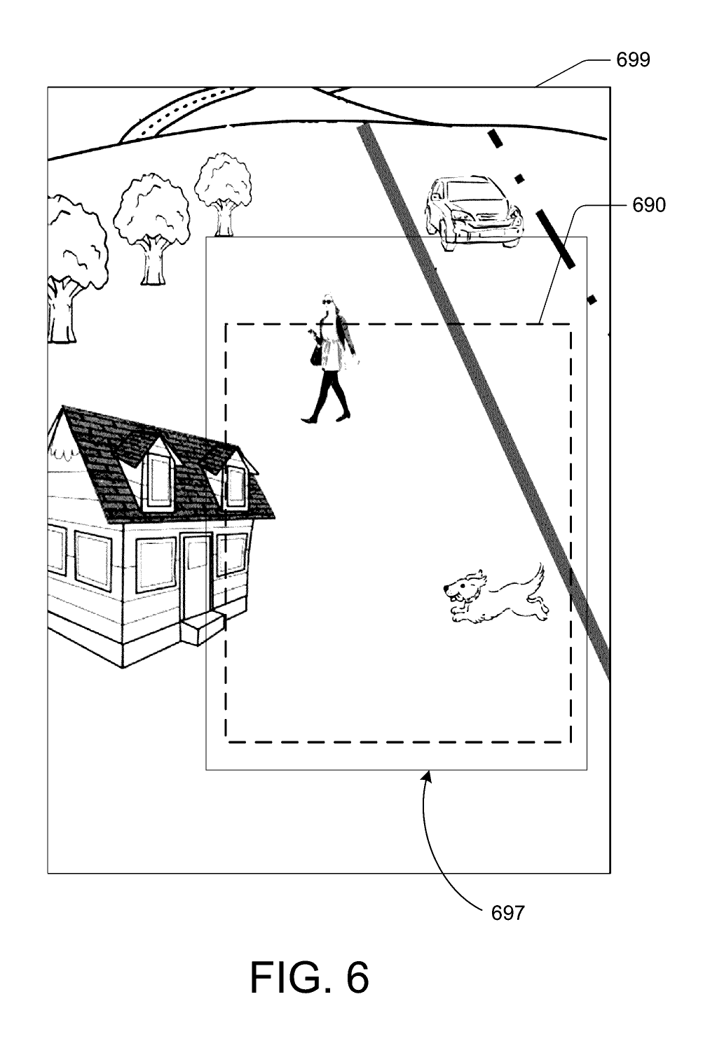

In scenario 100, the transparency-simulating apparatus may include a main camera 181 that faces surrounding 170. The transparency-simulating apparatus may receive data of an image of surrounding 170 taken by main camera 181 to create a see-through window such as see-through window 490 of FIG. 4 or see-through window 590 of FIG. 5. FIG. 6 is a diagram of an example construction of a see-through window in accordance with an implementation of the present disclosure. Image 699 of FIG. 6 may be a photo of a surrounding (e.g., surroundings 270, 470 or 570) taken by a camera (e.g., main camera 181 of FIG. 1). Based on computation methods described below, a see-through window 690 may be constructed out of image 699 for creating a visual effect of transparency when presented on a display such as display 380, 480 or 580.

An image of a surrounding, such as image 699 of FIG. 6, has a viewing angle associated with the image. Specifically, the viewing angle is a three-dimensional (3D) geometric parameter with which the image is taken by a camera (e.g., main camera 181). The viewing angle is related to a focal length with which the camera takes the image. In general, the longer the focal length, the narrower the viewing angle of the image; and the shorter the focal length, the wider the viewing angle of the image.

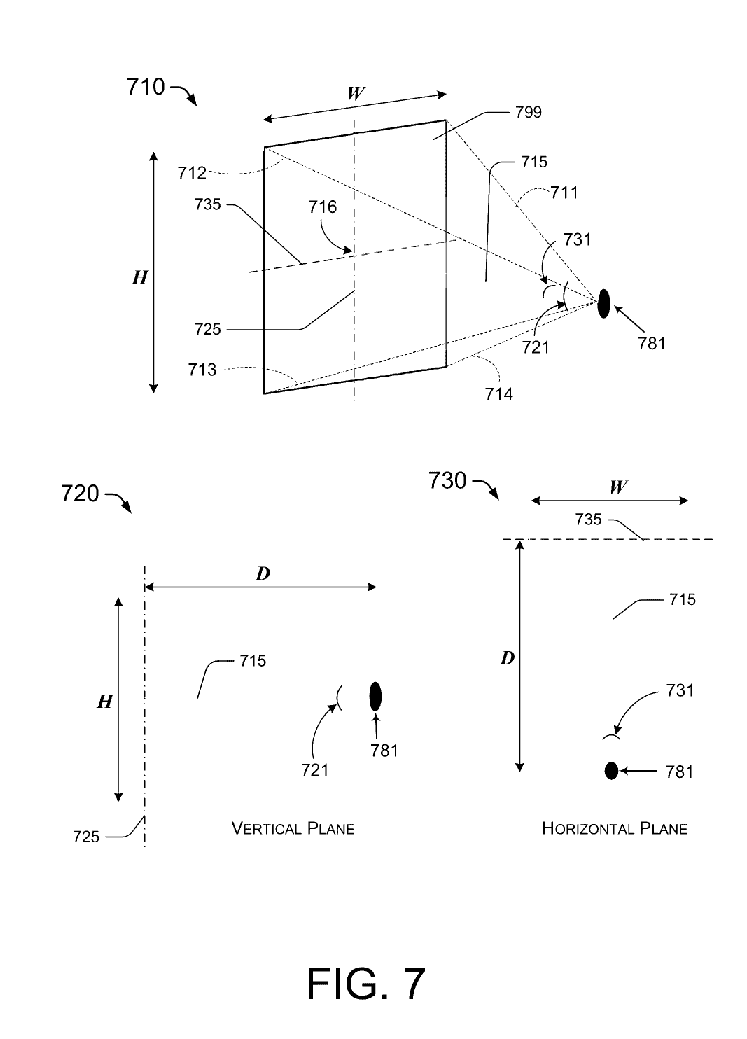

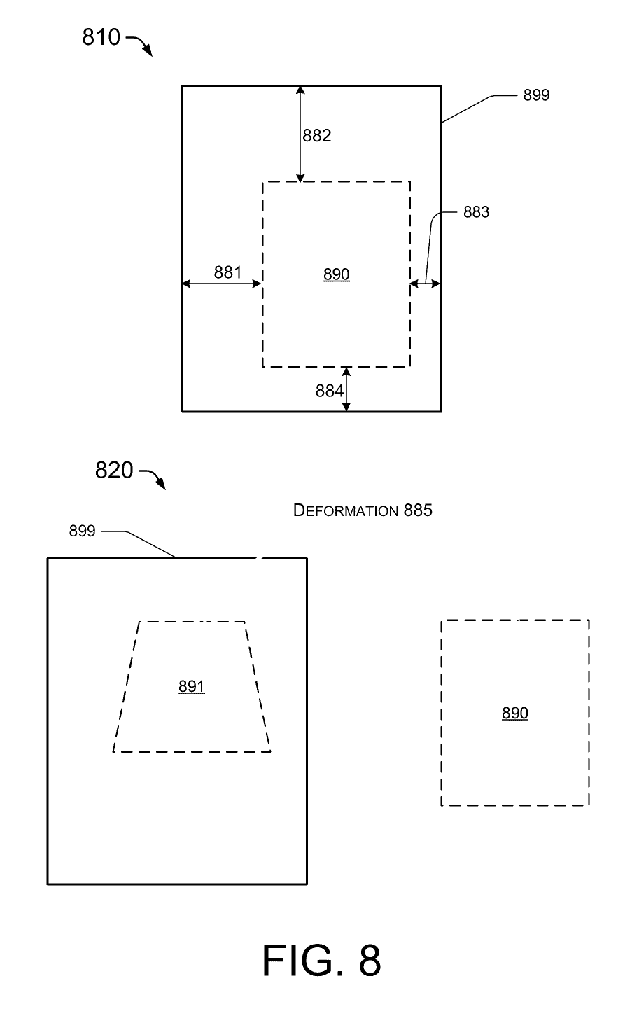

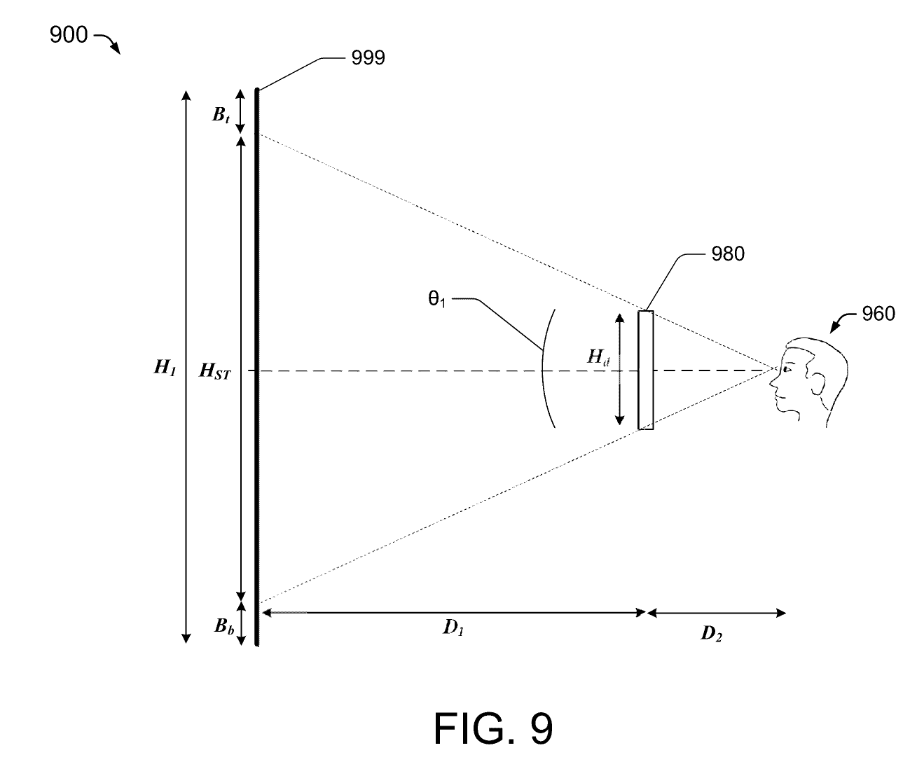

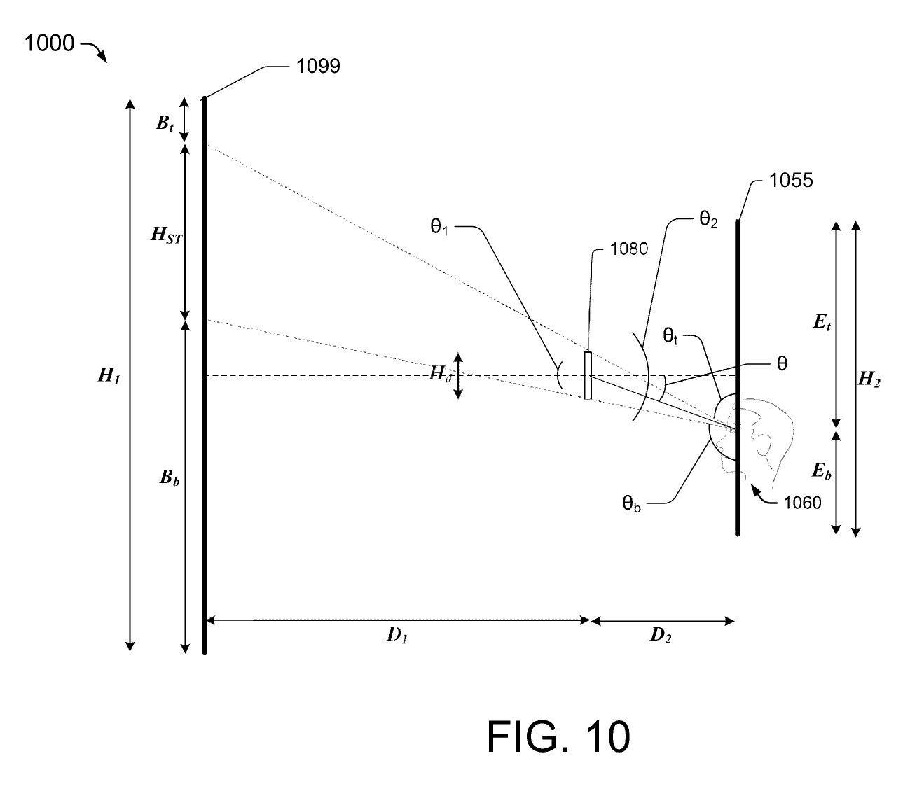

FIG. 7 is a diagram depicting a viewing angle 710 of an image in accordance with an implementation of the present disclosure. The image is captured by a camera 781 with a focal plane 799. Focal plane 799 is a rectangle and has a size of W×H, and objects on focal plane 799, within the size of W×H, are supposed to be clearly captured on the image. Each of imaginary lines 711, 712, 713 and 714 extends from camera 781 to a respective corner of focal plane 799. Focal plane 799 and imaginary lines 711, 712, 713 and 714 collectively define a volume of pyramid shape (hereinafter “the pyramid”), with a distance between the top of the pyramid and focal plane 799 denoted as D. The top geometric feature of the pyramid defines viewing angle 710 of the image.

To simplify computation and analysis of the 3D pyramid depicted in FIG. 7, viewing angle 710 may be equivalently replaced by a corresponding set of two angles, namely, angle 721 and angle 731 as shown in FIG. 7. Specifically, angle 721 is the top angle of an isosceles triangle 720 representing a cross-section, in a vertical direction of focal plane 799, of the pyramid. Likewise, angle 731 is the top angle of an isosceles triangle 730 representing a cross-section, in a horizontal direction of focal plane 799, of the pyramid. The bottom side of isosceles triangle 720 is denoted as side 725, and the bottom side of isosceles triangle 730 is denoted as side 735. Sides 725 and 735 are orthogonal to one another on focal plane 799, and cross one another at point 716. Sides 725 and 735 are also orthogonal to an imaginary line 715 connecting between camera 781 and point 716. Consequently, computation and analysis of the 3D pyramid related to viewing angle 710 of the image can be simplified as computation and analysis of isosceles triangles 720 and 730 for the vertical direction and the horizontal direction, respectively. This simplification approach is utilized in the computation and analysis described below.

As described in FIG. 6, see-through window 690 is constructed out of image 699. The construction of see-through window 690 may be realized by either a cropping process illustrated in process 810 of FIG. 8, or by a cropping-and-deforming process illustrated in process 820 of FIG. 8. That is, in some embodiments, the construction of a see-through window may involve process 810, while in some other embodiments, the construction of a see-through window may involve process 820. Process 810 involves computing a set of cropping parameters 881, 882, 883 and 884 as illustrated in FIG. 8, and applying the set of cropping parameters 881, 882, 883 and 884 to image 899 such that see-through window 890 is constructed from image 899 according to the set of cropping parameters 881, 882, 883 and 884. On the other hand, process 820 involves computing a set of cropping parameters that defines a cropped region 891 of image 899, as well as a set of deforming parameters that defines a deformation 885 that deforms cropped region 891 into see-through window 890. Whether see-through window 890 is realized by either process 810 or process 820 depends on a relative spatial relationship between a user and a camera taking image 899. In general, when a line of sight (LOS) from the user to the surrounding is too much out of line with a LOS from the camera to the surrounding, a deformation operation such as deformation 885 of process 820 may be more likely required to construct a suitable see-through window.

In some embodiments, instead of constructing see-through 890 out of image 899, a new image 899 may be taken and used to re-calculate an updated set of cropping parameters and/or an updated set of deforming parameters. That is, the original (i.e., non-zoomed-in) image 899 may serve as a “preview image” of the surrounding, and the set(s) of cropping/deforming parameters generated from the “preview image” may serve as a first pass calculation used to find or determine an optical zoom setting of the camera. With the camera adjusted to using the determined optical zoom setting, an updated (i.e., a zoomed-in version of) image 899, or the “zoomed image” of the same surrounding, is taken and used to calculate the updated set(s) of cropping/deforming parameters. The final see-through window to be presented on the display is then constructed from the zoomed image using the updated set(s) of cropping/deforming parameters. The purpose of this two-step approach that involves an adjustment of the optical zoom setting of the camera is to maximize a pixel resolution of the see-through window.

FIG. 6 may be utilized to further demonstrate the concept of the two-step approach. Image 699 may be the preview image of the two-step approach, and see-through window 690 may be constructed from preview image 699. As can be seen in FIG. 6, quite much area of preview image 699 is cropped out to construct see-through window 690. The see-through window 690 constructed from preview image 699 may contain about half or even less of the image pixels of preview image 699. Knowing that the see-through window 690 needed is of the size indicated in FIG. 6, an optical zooming setting of the camera may be adjusted (e.g., to have a higher zoom setting) such that an updated image of the same surrounding covers an area indicated by a “zoomed image” 697 shown in FIG. 6. Note that zoomed image 697 taken with the adjusted optical zooming setting has the same number of image pixels as that of the “preview image” 690 taken with the original optical zoom setting, and that see-through window 690 as constructed from zoomed image 697 keeps a higher percentage of area from zoomed image 697. It follows that the second see-through window 690, constructed from zoomed image 697, will have a higher image pixel count, and thus a higher pixel resolution, than that of the first see-through window 690, constructed from preview image 690. The optical zoom setting may be adjusted such that the size of zoomed image 697 approximate that of second see-through window 690 as closely as possible, thereby maximizing the pixel resolution of the resulted see-through window 690.

FIG. 9 depicts an example spatial relationship 900 among a display 980 having a height H_{d}, a focal plane 999 of an image of a surrounding (taken by a camera integrated with display 980), and a user 960, as seen on a vertical plane parallel with a standing-straight direction of user 960. In spatial relationship 900, the eyes of user 960 are aligned with the center (in the vertical direction) of display 980 in a horizontal direction. Based on spatial relationship 900 and through trigonometric computations, a set of cropping parameters (similar to cropping parameters 882 and 884 of FIG. 8) may be determined, and a see-through window may be accordingly constructed from the image of the surrounding. As shown in FIG. 9, the image of the surrounding is taken by a camera located at the center (in the vertical direction) of display 980 with a viewing angle θ₁ (on the vertical plane, similar to viewing angle 721 of FIG. 7). The image may capture a size of H₁ on the focal plane 999 in the vertical direction, but user 960 may only see a portion of H₁, denoted as H_{ST}, in a see-through window. An upper portion of H₁, denoted as Bₜ, as well as a lower portion of H₁, denoted as B_{b}, are not to be seen in the as in see-through window by user 960. Therefore, the purpose of the trigonometric computations is to arrive at a ratio of (Bₜ/H₁) and a ratio of (B_{b}/H₁). Based on the set of cropping parameters (Bₜ/H₁) and (B_{b}/H₁), the see-through window can be constructed accordingly from the image. It can be derived that each of (Bₜ/H₁) and (B_{b}/H₁) is equal to:

0.5*[1−(1+D₁/D₂)(H_{d}/(2*D₁*tan(θ₁/2)))]. [EQ1]

Given that viewing angle θ₁ is a known value as part of the image, and height H_{d} of display 980 is also a known value, the cropping parameters (Bₜ/H₁) and (B_{b}/H₁) can be readily calculated as long as D₁ (distance between display 980 and focal plane 999 of the surrounding) and D₂ (distance between display 980 and user 960) are known.

In some embodiments, either or both of D₁ and D₂ can be substituted by some predetermined, typical value(s) for common situations. That is, even though D₁ and D₂ may not be readily known, some typical values may be used for them for the calculation of the cropping parameters. For example, if display 960 is a cell phone, a typical value for D₂ may be 0.5 meters, and a typical value for D₁ may be 5-10 meters. Even if the predetermined typical values do not match the actual situation, certain degree of simulated transparency, though not perfect, can still be realized according to an implementation of the present disclosure.

In some embodiments, D₁ may be determined more accurately if the camera is a dual-lens or multi-lens camera. With the two or more lenses of the camera, a series of focusing operations may be performed to better estimate D₁. That is, images of a same object of different focal lengths can be taken and analyzed, and a more accurate estimation of D₁ may be achieved. In some embodiments, a dedicated distance detection sensor may be used along with the camera to get a more accurate estimation of D₁.

In some embodiments, the construction of the see-through window may incorporate 3D modeling of the surrounding if the camera is a dual-lens or multi-lens camera. Using a 3D modeling terminology, the camera may perform an operation of “segmentation” on the surrounding. Specifically, the camera may take multiple images, rather than just a single image, of the surrounding. Each of the multiple images of the surrounding may be taken on a respectively different focal plane with respect to the camera. That is, each image of the surrounding may be taken at a respectively different focal plane 999 of FIG. 9, denoted by a respectively different value of D₁. A respective see-through window may subsequently be constructed from each of the images, and 3D merging techniques may be employed in presenting the constructed see-through windows on the display. The see-through windows may then be three-dimensionally merged into a 3D see-through window. The 3D see-through window, when presented on the display, may create a visual effect of transparency to the user that is similar to the visual effect of transparency depicted in FIG. 4 (which is created by see-through window 490 of a single focal plane), but with a 3D visual presentation. The see-through window with 3D modeling, or the 3D see-through window, may match the actual surrounding in a more realistic way, thereby creating a more real visual effect of transparency.

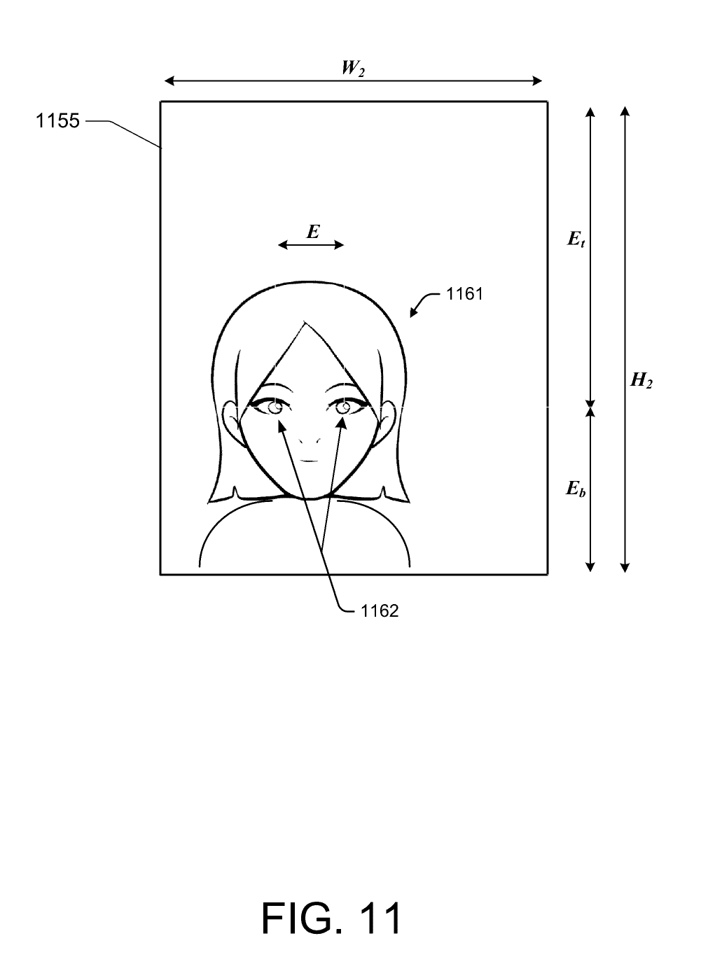

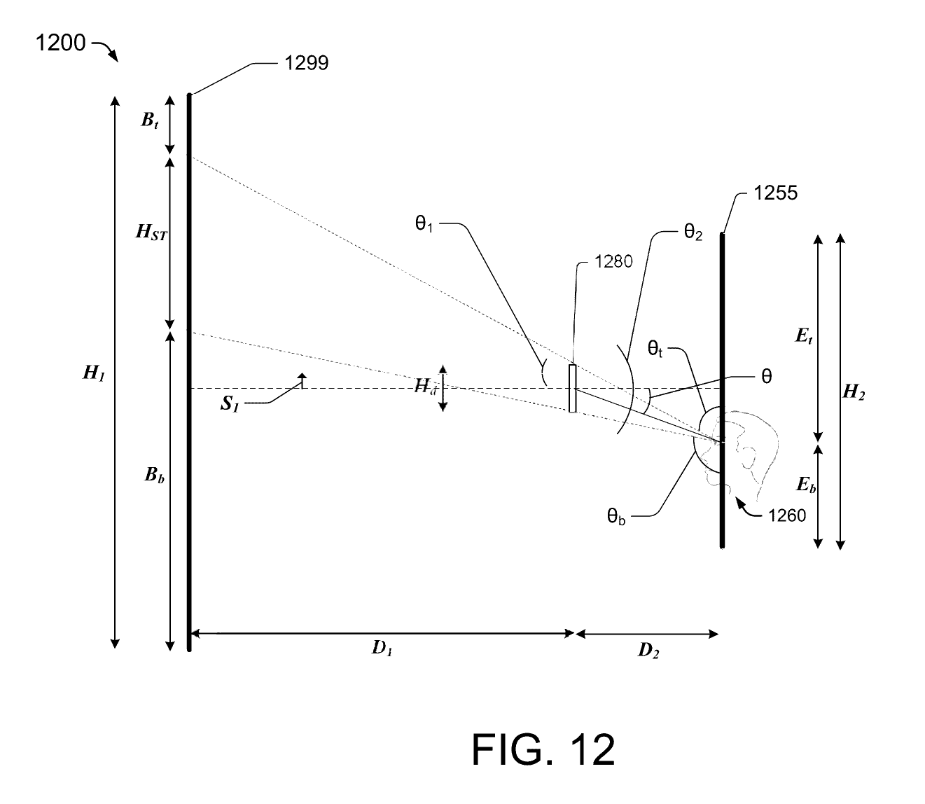

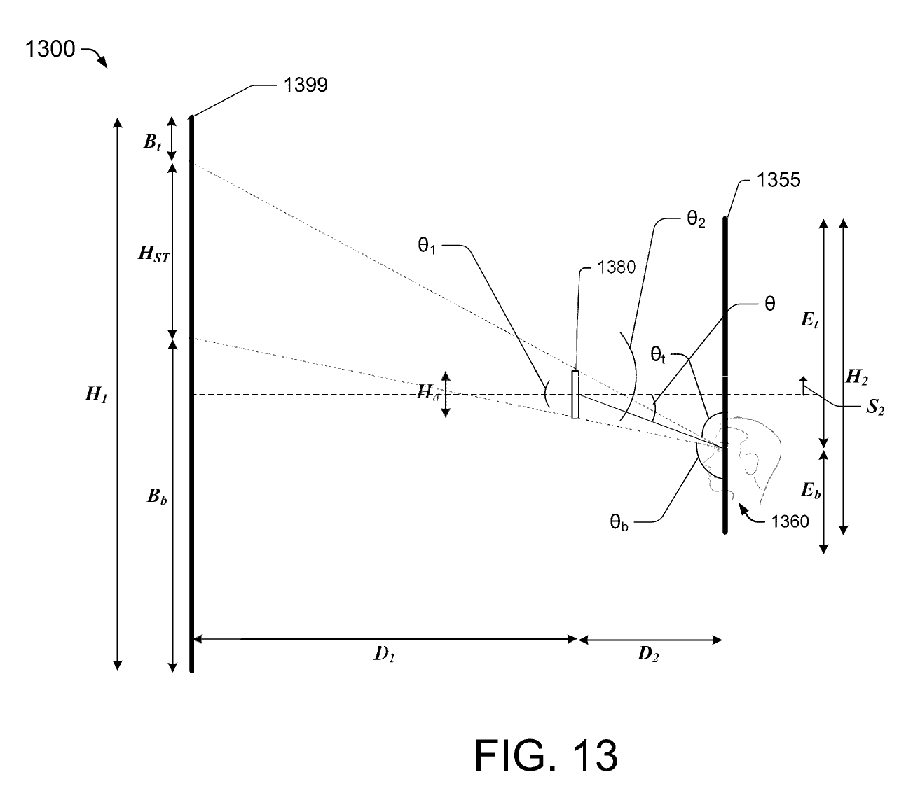

FIG. 10 depicts an example spatial relationship 1000 among a display 1080 having a height H_{d}, a focal plane 1099 of an image of a surrounding (taken by a main, or first, camera integrated with display 1080), and a user 1060, as seen on a vertical plane parallel with a standing-straight direction of user 1060. In spatial relationship 1000, the eyes of user 1060 are not aligned with the center (in the vertical direction) of display 980 in a horizontal direction. Rather, the eyes of user 1060 are shifted lower than the center of display 980. Based on spatial relationship 1000 and through trigonometric computations, a set of cropping parameters (similar to cropping parameters 882 and 884 of FIG. 8) may be determined, and a see-through window may be accordingly constructed from the image of the surrounding. To compute the cropping parameters from spatial relationship 1000, an additional, or front, camera (such as front camera 182 of FIG. 1) may be utilized. The second camera may be integrated with display 1080, facing user 1060, and capturing an image of user 1060 at focal plane 1055 with a few angle denoted as θ₂. An image of user 1060 may be similar to image 1155 of user 1160 as shown in FIG. 11, having a height of H₂. The location of the eyes 1162 of user 1160 divides, in a vertical direction, height H₂ into an upper portion denoted by Eₜ and a lower portion denoted by E_{b}. Similarly, the location of the eyes of user 1060 also divides, in a vertical direction, height H₂ into an upper portion denoted by Eₜ and a lower portion denoted by E_{b}.

A set of related angles, such as angles θ, θₜ and θ_{b} of FIG. 10, are used to denote where user 1060 is located in the image of user 1060, in the vertical direction. Various parameters of FIG. 10 are interrelated through the following trigonometric equations:

tan θ=(2*Eₜ/H₂−1)*tan(θ₂/2) [EQ2]

cot θₜ=0.5*(H_{d}/D₂)+tan θ [EQ3]

cot θ_{b}=0.5*(H_{d}/D₂)−tan θ[EQ4]

H₁=2*D₁*tan(θ₁/2) [EQ5]

H₂=2*D₂*tan(θ_{2/}2) [EQ6]

Accordingly, the set of cropping parameters can be readily derived as:

(Bₜ/H₁)=0.5*(1−H_{d}/D₁)−(D₁/H₁)*cot θₜ [EQ7]

(B_{b}/H₁)=0.5*(1−H_{d}/D₁)−(D₁/H₁)*cot θ_{b} [EQ8]

Among the various parameters, viewing angle θ₁ is a known value as part of the image of the surrounding, and viewing angle θ₂ is also a known value as part of the image of user 1060. Height H_{d} of display 1080 is known, and (Eₜ/H₂) can be derived from an analysis of the image of user 1060. Alternatively, (Eₜ/H₂) can use a predetermined typical value. Therefore, the cropping parameters (Bₜ/H₁) and (B_{b}/H₁) can be readily calculated as long as D₁ (distance between display 1080 and focal plane 1099 of the surrounding) and D₂ (distance between display 1080 and user 1060) are known.

Various techniques for determining or estimating D₁ are disclosed above, and the same techniques may be applied to the determining or estimating of D₂. That is, D₂ may be substituted by some predetermined, typical value, such as 0.5 meters. Alternatively, D₂ may be determined or estimated more accurately provided that the front camera is a dual-lens or multi-lens camera and that a series of focusing operations is performed. Alternatively, D₂ may be determined or estimated using a dedicated distance detection sensor. In addition, when display 1080 is a cell phone that is typically used by a single particular user, a size or area of head 1161 of the user on image 1155, as shown in FIG. 11, may be used to estimate D₂. That is, assuming that an actual size of head 1161 of the particular used should not change, a larger size of head 1161 of the user on image 1155 may indicate that the user is closer to the front camera, whereas a smaller size of head 1161 on image 1155 may indicate that the user is farther away from the front camera. Therefore, D₂ may also be obtained or at least estimated by analyzing image 1155.

FIG. 12 illustrates an example spatial relationship 1200 among a display 1280, a focal plane 1299 of a photo of a surrounding, a user 1260, and a focal plane 1255 of a photo of user 1260. Spatial relationship 1200 is similar to spatial relationship 1000 of FIG. 10, with the only difference being that the main camera facing the surrounding is shifted upward by a distance of S₁ relative to a center of display 1280. By similar trigonometric calculations as performed for spatial relationship 1000, equations EQ2-EQ6 still hold for spatial relationship 1200, while EQ7 and EQ8 are to be lightly modified to EQ7S and EQ8S as shown below to arrive at a set of cropping instructions for spatial relationship 1200:

(Bₜ/H₁)=0.5*(1−H_{d}/D₁)−(D₁/H₁)*cot θₜ+S₁/H₁ [EQ7S]

(B_{b}/H₁)=0.5*(1−H_{d}/D₁)−(D₁/H₁)*cot θ_{b}−S₁/H₁ [EQ8S]

Note that S₁ is typically a known design parameter value.

FIG. 13 illustrates an example spatial relationship 1300 among a display 1380, a focal plane 1399 of a photo of a surrounding, a user 1360, and a focal plane 1355 of a photo of user 1360. Spatial relationship 1300 is similar to spatial relationship 1000 of FIG. 10, with the only difference being that the front camera facing the user is shifted upward by a distance of S₂ relative to a center of display 1380. By similar trigonometric calculations as performed for spatial relationship 1000, equations EQ3-EQ8 still hold for spatial relationship 1300, while EQ2 is to be lightly modified to EQ2S as shown below:

tan θ=(2*Eₜ/H₂−1−2*S₂/H₂)*tan(θ₂/2) [EQ2S]

With EQ2S replacing EQ2, the set of cropping instructions presented in EQ7 and EQ8 stands valid for spatial relationship 1300. Note that S₂ is typically a known design parameter value.

FIG. 14 illustrates side view 1410 and top view 1420 of an example spatial relationship among a display, a focal plane 1499 of an image of a surrounding, and a user 1460. Without considering a distance between the eyes of user 1460 (such as the in-between-eye distance denoted as E in FIG. 11), a see-through window has a definite width of W_{ST} as shown in top view 1420. However, when the distance between the eyes of user 1460 is considered, as shown in top view 1430, the size of the see-through window in the horizontal direction may change. Specifically, with only left eye open and right eye closed, user 1460 has a see-through window 1491 as shown in top view 1430. However, with only right eye open and left eye closed, user 1460 has a see-through window 1492 as shown in top view 1430. Therefore, the see-through window may be constructed with a width between Wₘᵢₙ and Wₘₐₓ as denoted in top view 1430 of FIG. 14, wherein Wₘₐₓ is a union of see-through windows 1491 and 1492, and wherein Wₘᵢₙ is an intersection of see-through windows 1491 and 1492.

### Illustrative Implementations

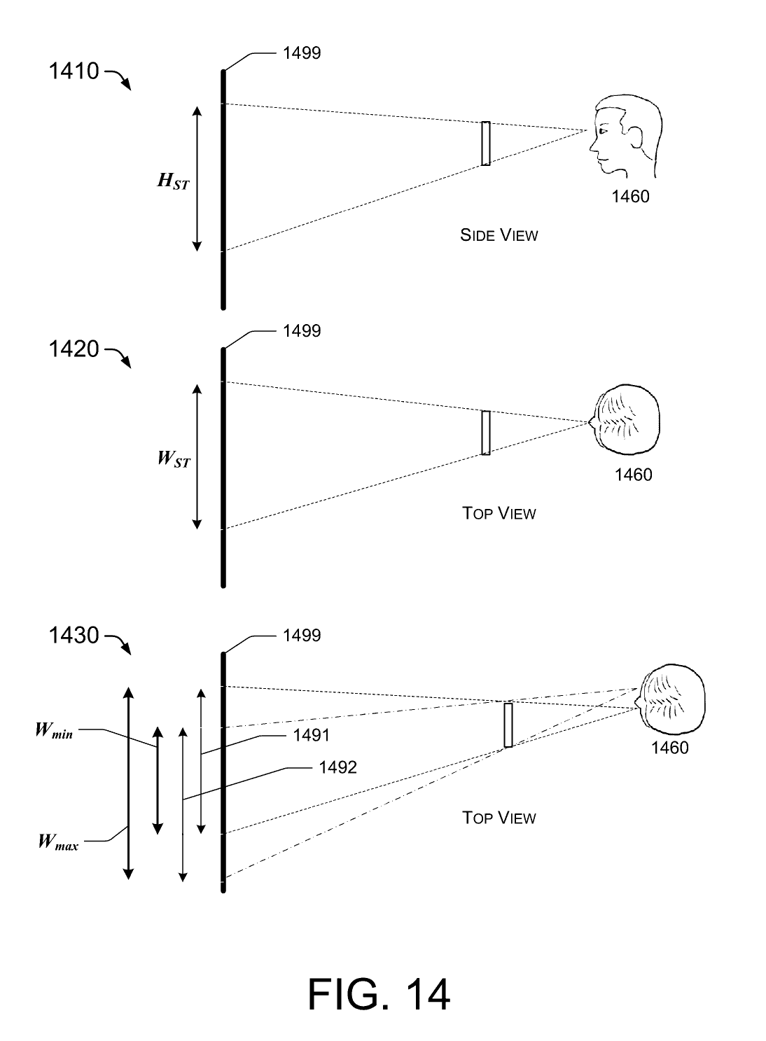

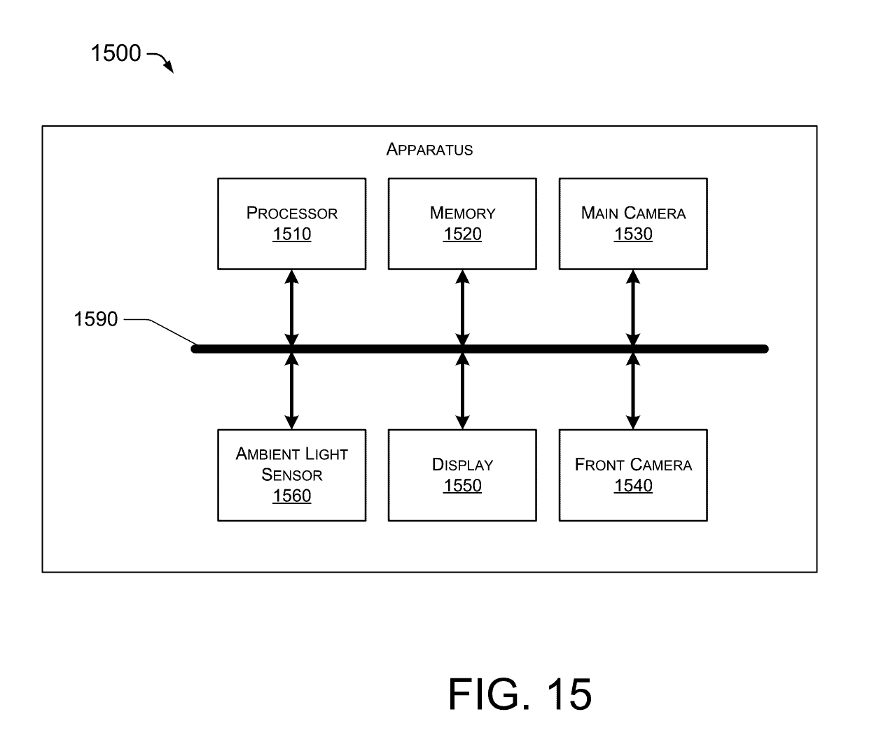

FIG. 15 illustrates an example apparatus, or transparency-simulating apparatus 1500, in accordance with an embodiment of the present disclosure. Transparency-simulating apparatus 1500 may perform various functions related to techniques, methods and systems described herein, including those described above with respect to FIGS. 1-14 and below with respect to process 1600, with respect to constructing and presenting a see-through window to create a visual effect of simulated transparency for an essentially opaque display. Transparency-simulating apparatus 1500 may include at least some of the components illustrated in FIG. 15.

Transparency-simulating apparatus 1500 may include a special-purpose processor 1510 implemented in the form of one or more integrated-circuit (IC) chips and any supporting electronics, and may be installed in an electronic device or system carried by user 160, such as a computer (e.g., a personal computer, a tablet computer, a personal digital assistant (PDA)), a cell phone, a game console, and the like. In other words, transparency-simulating apparatus 1500 may be implemented in or as a portable device or a stationary device. Processor 1510 may be communicatively connected to various other operational components of transparency-simulating apparatus 1500 through communication bus 1590. Communication bus 1590 collectively represents all system, peripheral, and chipset buses that communicatively connect the numerous internal components of transparency-simulating apparatus 1500. For instance, transparency-simulating apparatus 1500 may also include a memory device 1520, and processor 1510 may communicatively connect to memory device 1520 through communication bus 1590. Memory device 1520 may be configured to store data, firmware and software programs therein. For example, memory device 1520 may store one or more sets of instructions such that, when processor 1510 executes the instructions, processor 1510 may be configured to receive data of images of a surrounding and of a user, to construct a see-through window for the image of the surrounding according to the methods described above with respect to FIGS. 1-14, and to present the see-through window on a display to create a visual effect with which at least a portion of the display may be substantially transparent to the user.

In some embodiments, transparency-simulating apparatus 1500 may also include a main camera 1530 (such as camera 181 of FIG. 1) with which the image of the surrounding may be captured. Main camera 1530 may be able to send the image of the surrounding (such as image 699 of FIG. 6) to processor 1510 via communication bus 1590 for further analysis (such as determining the cropping and deforming parameters in processes 810 and 820 of FIG. 8) and processing (such as adjusting color temperature and blending with app buttons 594 and AR object 595 for see-through window 590). In some embodiments, transparency-simulating apparatus 1500 may further include a front camera 1540 facing the user (such as camera 182 of FIG. 1) with which the image of the user may be captured. Front camera 1540 may be able to send the image of the user (such as image 1155 of FIG. 11) to processor 1510 via communication bus 1590 for further analysis (such as determining E, Eₜ/H₂ and E_{b}/H₂ for FIG. 8).

In some embodiments, transparency-simulating apparatus 1500 may include a display 1550 (such as displays 480 and 580) which may be the display that the see-through window may be presented on. In some embodiments, either or both of main camera 1530 and front camera 1540 may be integrated with display 1550. In some embodiments, transparency-simulating apparatus 1500 may include an ambient light sensor 1560 that provides red-green-blue (RGB) data of the surrounding. Ambient light sensor 1560 may send the RGB data to processor 1510 through communication bus 1590. Processor 1510 may be configured to determine a color temperature setting based on either the image of the surrounding or RGB data from ambient light sensor 1560, and to present the see-through window on display 1550 with the color temperature setting.

In some embodiments, cameras 1530 and 1540 may adaptively and continually capture images and send them to processor 1510. Processor 1510 may be configured to adaptively and continually construct the see-through window and present it on the display. Accordingly, the display stays substantially transparent to the user, even in response to a relative movement of any of the user, the display, and the surrounding with respect to any other thereof.

In some embodiments, the image may be associated with a viewing angle, and may be captured by main camera 1530 or front camera 1540 with the viewing angle. In constructing the see-through window, processor 1510 may be configured to perform a number of operations. For instance, processor 1510 may determine a first spatial relationship denoting a location of the surrounding with respect to display 1550. Processor 1510 may also determine a second spatial relationship denoting a location of the user with respect to display 1550. Processor may also compute a set of cropping parameters, a set of deforming parameters, or both, based on the first spatial relationship, the second spatial relationship, the viewing angle of the image, and a dimension of display 1550. Processor 1510 may apply the set of cropping parameters, the set of deforming parameters, or both, to the image to generate the see-through window.

In some embodiments, in determining the first spatial relationship, processor 1510 may be configured to determine the first spatial relationship using a predetermined first distance, with the first distance denoting the location of the surrounding with respect to display 1550. Moreover, in determining the second spatial relationship, processor 1510 may be configured to determine the second spatial relationship using a predetermined second distance and a predetermined set of angles, with the second distance and the set of angles collectively denoting the location of the user with respect to display 1550.

In some embodiments, the image of the surrounding may be a first image, and the viewing angle of the image may be a first viewing angle. Processor 1510 may be further configured to receive data of an image of the user from front camera 1540. The image of the user may be a second image, and may be associated with a second viewing angle. The second image may be captured by front camera 1540 with the second viewing angle.

In some embodiments, in computing the set of cropping parameters, the set of deforming parameters, or both, processor 1510 may be configured to compute the set of cropping parameters, the set of deforming parameters, or both, based on the first spatial relationship, the second spatial relationship, the first viewing angle, the dimension of display 1550, and the second viewing angle.

In some embodiments, in determining the first spatial relationship, processor 1510 may be configured to determine the first spatial relationship using a first distance, the first distance denoting the location of the surrounding with respect to display 1550. The first distance may be estimated either by main camera 1530 performing focusing operations on the surrounding or by processor 1510 analyzing the first image. Moreover, in determining the second spatial relationship, processor 1510 may be configured to determine the second spatial relationship using a second distance and a set of angles, the second distance and the set of angles collectively denoting the location of the user with respect to display 1550. The second distance and the set of angles may be estimated either by front camera 1540 performing focusing operations on the user or by processor 1510 analyzing the second image.

In some embodiments, in analyzing the second image, processor 1510 may be configured to determine positions of eyes of the user, a spacing between the eyes of the user, an area of a head of the user as captured in the second image, or a combination of two or more thereof, by applying one or more face detection techniques to the second image.

In some embodiments, the image may be a preview image. In such cases, in constructing the see-through window, processor 1510 may be configured to perform a number of operations. For instance, processor 1510 may determine a first spatial relationship denoting a location of the surrounding with respect to display 1550, and also determine a second spatial relationship denoting a location of the user with respect to display 1550. Processor 1510 may compute a first set of cropping parameters, a first set of deforming parameters, or both, based on the first spatial relationship, the second spatial relationship, a viewing angle of the preview image, and a dimension of display 1550. Processor 1510 may determine an optical zoom setting of main camera 1530, which captures the image, based on the first set of cropping parameters, the first set of deforming parameters, or both, such that the optical zoom setting maximizes a pixel resolution of the see-through window. Processor 1510 may receive data of a zoomed image of the surrounding from the camera, with the optical zoom setting applied to the camera. Processor 1510 may compute a second set of cropping parameters, a second set of deforming parameters, or both, based on the first spatial relationship, the second spatial relationship, a viewing angle of the zoomed image, and the dimension of display 1550. Processor 1510 may apply the second set of cropping parameters, the second set of deforming parameters, or both, to the zoomed image to generate the see-through window.

In some embodiments, in presenting the see-through window on display 1550, processor 1510 may be configured to determine a color temperature setting for the see-through window. Additionally, processor 1510 may present the see-through window on display 1550 with the color temperature setting.

In some embodiments, in presenting the see-through window on display 1550, processor 1510 may be configured to blur at least a part of the see-through window to create a second visual effect of a substantially single depth of focus of human eyes. Moreover, processor 1510 may present the see-through window on display 1550 with the second visual effect.

In some embodiments, in presenting the see-through window on display 1550, processor 1510 may be configured to determine a transparency setting for the see-through window. Moreover, processor 1510 may present the see-through window on display 1550 with the transparency setting along with one or more other displaying objects. The one or more other displaying objects may include one or more icons, one or more buttons, one or more GUI objects, or one or more AR objects.

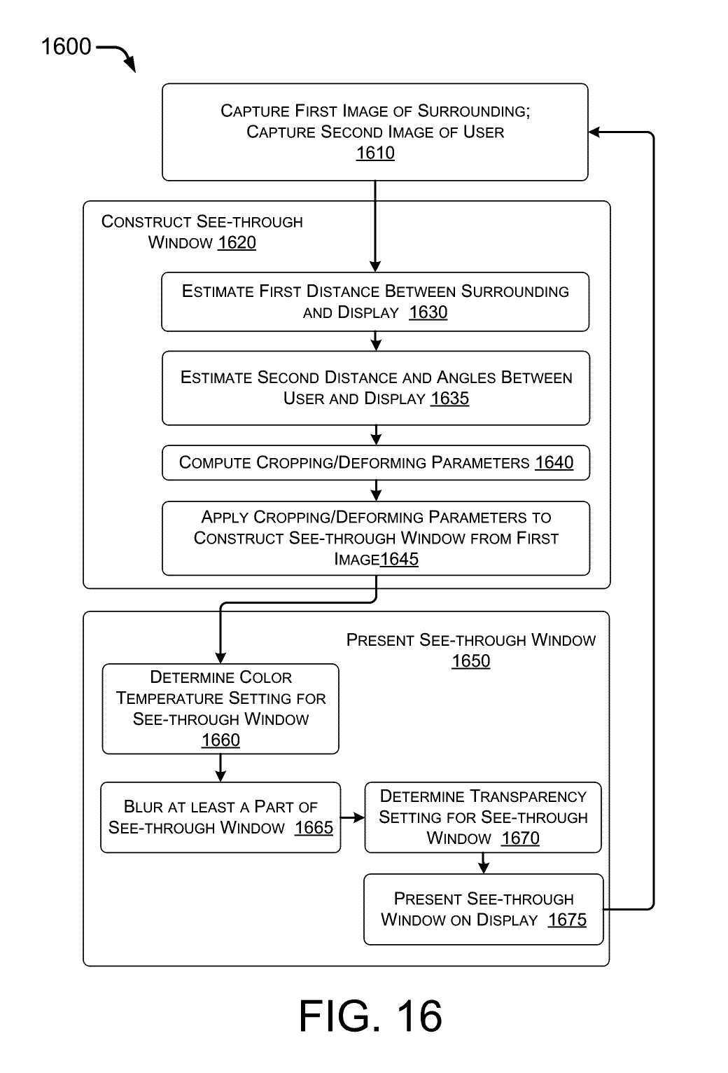

FIG. 16 illustrates an example process 1600, in accordance with the present disclosure, for simulating a display to be substantially transparent to a user. Process 1600 may include one or more operations, actions, or functions shown as blocks such as 1610, 1620 and 1650 as well as sub-blocks 1630, 1635, 1640, 1645, 1660, 1665, 1670 and 1675. Although illustrated as discrete blocks, various blocks of process 1600 may be divided into additional blocks, combined into fewer blocks, or eliminated, depending on the desired implementation. Moreover, the various blocks of process 1600 may be performed or otherwise carried out in an order different from that shown in FIG. 16. Process 1600 may be implemented by transparency-simulating apparatus 1500, any variations and any derivatives thereof. In addition, process 1600 may be utilized to generate a simulated transparent display such as display 480 of FIG. 4 and display 580 of FIG. 5. For illustrative purpose and without limitation, process 1600 is described below in the context of transparency-simulating apparatus 1500. Process 1600 may begin with block 1610.

At 1610, process 1600 may involve processor 1510 capturing a first image (such as image 699) of a surrounding (such as surrounding 170 or 470) of a display (such as display 180) with a first camera (such as main camera 181). The first image may have a viewing angle (such as viewing angle 710 of FIG. 7, which may be represented on a vertical plane by angle 721 of FIG. 7 or angle θ₁ of FIG. 10). At 1610, process 1600 may also involve processor 1510 capturing a second image (such as image 1155) of a user (such as user 160) of the display with a second camera (such as front camera 182). The second image may have a viewing angle (such as viewing angle 710 of FIG. 7, which may be represented on a vertical plane by angle 721 of FIG. 7 or angle θ₂ of FIG. 10). Process 1600 may proceed from 1610 to 1620.

At 1620, process 1600 may involve processor 1510 constructing a see-through window (such as see-through window 490 or 690) of the first image. When presented on the display, the see-through window substantially matches the surrounding and creates a visual effect with which at least a portion of the display may be substantially transparent to the user (such as the visual effect with which at least a portion of display 480 may be substantially transparent with see-through window 490 presented). Block 1620 may begin with sub-block 1630.

At 1630, process 1600 may involve processor 1510 estimating a first distance (such as D₁ of FIG. 10) using the first camera. The first distance may denote a location (such as focal plane 1099) of the surrounding with respect to the display (such as display 1080). Process 1600 may proceed from 1630 to 1635.

At 1635, process 1600 may involve processor 1510 estimating a second distance (such as D₂ of FIG. 10) and a set of angles (such as θ, θₜ and θ_{b} in FIG. 10) using either or both of the second camera and the second image. The second distance and the set of angles, collectively, may denote a location (such as focal plane 1055) of the user with respect to the display (such as display 1080). Process 1600 may proceed from 1635 to 1640.

At 1640, process 1600 may involve processor 1510 computing a set of cropping parameters (such as 881, 882, 883 and 884 of cropping process 810), a set of deforming parameters, or a combination of both (such as cropping-and-deforming process 820). The computing of the cropping parameters, the deforming parameters, or a combination of both, may be based on the first spatial relationship (such as D₁ of FIG. 10), the second spatial relationship (such as D₂ and θ, θₜ and θ_{b} of FIG. 10), the first viewing angle (such as θ₁ of FIG. 10), the second viewing angle (such as θ₂ of FIG. 10), and a dimension of the display (such as H_{d} of FIG. 10). For example, the cropping parameters of FIG. 10 may be determine by equations EQ2-8. Process 1600 may proceed from 1640 to 1645.

At 1645, process 1600 may involve processor 1510 applying the set of cropping parameters, the set of deforming parameters, or both, to the first image (such as image 699) to generate the see-through window (such as 690 of FIG. 6). Process 1600 may proceed from 1645 to 1650.

At 1650, process 1600 may involve processor 1510 presenting the see-through window on the display. When presented on the display, the see-through window substantially matches the surrounding and creates a visual effect with which at least a portion of the display may be substantially transparent to the user (such as the visual effect with which display 480 may be substantially transparent with see-through window 490 presented). Block 1650 may begin with sub-block 1660.

At 1660, process 1600 may involve processor 1510 determining a color temperature setting for the see-through window. For example, a color temperature setting of see-through window 590 of FIG. 5 may be determined and/or adjusted by RGB data provided by ambient light sensor 1560. Alternatively, the color temperature setting may be determined based on the image of the surrounding. In some embodiments, the color temperature setting may be adjusted or determined such that the see-through window may have a color temperature that may be closer to that of the surrounding, thereby enhancing the matching between the see-through window and the surrounding. Process 1600 may proceed from 1660 to 1665.

At 1665, process 1600 may involve processor 1510 blurring at least a part of the see-through window to create a visual effect of a substantially single depth of focus of human eyes. For example, processor 1510 may blur, for see-through window 490 of FIG. 4, an area around or encompassing partial image 4739 (the pedestrian) blurred out to some extent such that, when presented along with image 4749 (the dog), which is not blurred out, a visual effect may be created that mimics a single depth of focus of human eyes, with the focus on the fog rather than on the pedestrian. Process 1600 may proceed from 1665 to 1670.

At 1670, process 1600 may involve processor 1510 determining a transparency setting for the see-through window. For example, processor 1510 may determine and/or adjust see-through window 590 of FIG. 5, according to either a user's preference or an algorithm. In some embodiments, processor 1510 may determine and/or adjust the transparency setting so as to enhance presentation quality or user experience regarding the see-through window, especially when the see-through window may be presented along with software touch buttons (such as 594 of FIG. 5) and/or an AR object (such as 595 of FIG. 5). Process 1600 may proceed from 1670 to 1675.

At 1675, process 1600 may involve processor 1510 presenting the see-through window on the display. In some embodiments, process 1600 may involve processor 1510 presenting the see-through window on the display with the color temperature setting determined in sub-block 1660. In some embodiments, process 1600 may involve processor 1510 presenting the see-through window on the display with the visual effect of the substantially single depth of focus of human eyes as created in sub-block 1665. In some embodiments, process 1600 may involve processor 1510 presenting the see-through window on the display with the transparency setting determined in sub-block 1670 along with one or more other displaying objects. The one or more other displaying objects may be one or more icons, buttons, GUI objects, or AR objects. Process 1600 may return from 1675 to 1610, forming a process loop therein.

By forming the process loop, process 1600 may involve processor 1510 adaptively and continually repeating the capturing of the first and second images, the constructing of the see-through window, and the presenting of the see-through window on the display such that the display appears to be substantially transparent to the user in response to a relative movement of any of the user, the display, and the surrounding with respect to any other thereof.

In some embodiments, in constructing the see-through window, process 1600 may involve a number of operations (e.g., performed by apparatus 1500). For instance, process 1600 may involve determining a first spatial relationship denoting a location of the surrounding with respect to the display. Process 1600 may also involve determining a second spatial relationship denoting a location of the user with respect to the display. Process 1600 may further involve computing a set of cropping parameters, a set of deforming parameters, or a combination of both, based on the first spatial relationship, the second spatial relationship, the first viewing angle, the second viewing angle, and a dimension of the display. Process 1600 may additionally involve applying the set of cropping parameters, the set of deforming parameters, or both, to the first image to generate the see-through window.

In some embodiments, in determining the first spatial relationship, process 1600 may involve estimating a first distance using main camera 1530, the first distance denoting the location of the surrounding with respect to the display. Additionally, in determining the second spatial relationship, process 1600 may involve estimating a second distance and a set of angles using either or both of the second camera (e.g., front camera 1540) and the second image, with the second distance and the set of angles collectively denoting the location of the user with respect to the display.

In some embodiments, each of the first and second cameras may be integrated with the display. In such cases, the computing of the set of cropping parameters, the set of deforming parameters, or both, may be further based on a respective offset between each of the first and second cameras and a center of the display.

In some embodiments, in presenting the see-through window on the display, process 1600 may involve determining a color temperature setting for the see-through window. Process 1600 may also involve presenting the see-through window on the display with the color temperature setting.

In some embodiments, in presenting the see-through window on the display, process 1600 may involve blurring at least a part of the see-through window to create a second visual effect of a substantially single depth of focus of human eyes. Moreover, process 1600 may involve presenting the see-through window on the display with the second visual effect.

In some embodiments, in presenting the see-through window on the display, process 1600 may involve determining a transparency setting for the see-through window. Furthermore, process 1600 may involve presenting the see-through window on the display with the transparency setting along with one or more other displaying objects. The one or more other displaying objects may include one or more icons, one or more buttons, one or more GUI objects, or one or more AR objects.

In some embodiments, process 1600 may also involve adaptively and continually repeating the capturing of the first and second images, the constructing of the see-through window, and the presenting of the see-through window on the display such that the display appears to be substantially transparent to the user in response to a relative movement of any of the user, the display, and the surrounding with respect to any other thereof.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure are described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus, comprising:
a memory configured to store one or more sets of instructions; and
a processor coupled to execute the one or more sets of instructions in the memory, the processor, upon executing the one or more sets of instructions, configured to perform operations comprising:
receiving data of an image of a surrounding of a display;
constructing a see-through window of the image, wherein, when presented on the display, the see-through window substantially matches the surrounding and creates a visual effect with which at least a portion of the display is substantially transparent to a user; and
presenting the see-through window on the display.

2. The apparatus of claim 1, wherein:
the image comprises a viewing angle, the image captured by a camera with the viewing angle, and
in constructing the see-through window, the processor is configured to perform operations comprising:
determining a first spatial relationship denoting a location of the surrounding with respect to the display;
determining a second spatial relationship denoting a location of the user with respect to the display;
computing a set of cropping parameters, a set of deforming parameters, or both, based on the first spatial relationship, the second spatial relationship, the viewing angle of the image, and a dimension of the display; and
applying the set of cropping parameters, the set of deforming parameters, or both, to the image to generate the see-through window.

3. The apparatus of claim 2, wherein:
in determining the first spatial relationship, the processor is configured to determine the first spatial relationship using a predetermined first distance, the first distance denoting the location of the surrounding with respect to the display, and
in determining the second spatial relationship, the processor is configured to determine the second spatial relationship using a predetermined second distance and a predetermined set of angles, the second distance and the set of angles collectively denoting the location of the user with respect to the display.

4. The apparatus of claim 2, further comprising:
the camera as a first camera;
a second camera; and
the display,
wherein:
the image of the surrounding is a first image,
the viewing angle of the image is a first viewing angle,
the processor is further configured to receive data of an image of the user from the second camera, the image of the user being a second image and comprising a second viewing angle, the second image captured by the second camera with the second viewing angle.

5. The apparatus of claim 4, wherein, in computing the set of cropping parameters, the set of deforming parameters, or both, the processor is configured to compute the set of cropping parameters, the set of deforming parameters, or both, based on the first spatial relationship, the second spatial relationship, the first viewing angle, the dimension of the display, and the second viewing angle.

6. The apparatus of claim 4, wherein:
in determining the first spatial relationship, the processor is configured to determine the first spatial relationship using a first distance, the first distance denoting the location of the surrounding with respect to the display, the first distance estimated either by the first camera performing focusing operations on the surrounding or by the processor analyzing the first image, and
in determining the second spatial relationship, the processor is configured to determine the second spatial relationship using a second distance and a set of angles, the second distance and the set of angles collectively denoting the location of the user with respect to the display, the second distance and the set of angles estimated either by the second camera performing focusing operations on the user or by the processor analyzing the second image.

7. The apparatus of claim 6, wherein, in analyzing the second image, the processor is configured to determine positions of eyes of the user, a spacing between the eyes of the user, an area of a head of the user as captured in the second image, or a combination of two or more thereof, by applying one or more face detection techniques to the second image.

8. The apparatus of claim 4, wherein:
the first camera is a multi-lens camera, and
the first image comprises a set of images of the surrounding, each of the set of images capturing at least one part of the surrounding on a respectively different focal plane with respect to the first camera,

9. The apparatus of claim 8, wherein:
in determining the first spatial relationship, the processor is configured to determine the first spatial relationship using a set of first distances, each of the set of first distances denoting a location of the at least one part of the surrounding captured on one of the set of images with respect to the display, each of the set of first distances estimated either by the first camera performing focusing operations on the surrounding or by the processor analyzing the first image, and
in determining the second spatial relationship, the processor is configured to determine the second spatial relationship using a second distance and a set of angles, the second distance and the set of angles collectively denoting the location of the user with respect to the display, the second distance and the set of angles estimated either by the second camera performing focusing operations on the user or by the processor analyzing the second image.

10. The apparatus of claim 1, wherein the image is a preview image, and wherein, in constructing the see-through window, the processor is configured to perform operations comprising:
determining a first spatial relationship denoting a location of the surrounding with respect to the display;
determining a second spatial relationship denoting a location of the user with respect to the display;
computing a first set of cropping parameters, a first set of deforming parameters, or both, based on the first spatial relationship, the second spatial relationship, a viewing angle of the preview image, and a dimension of the display;
determining an optical zoom setting of a camera that captures the image based on the first set of cropping parameters, the first set of deforming parameters, or both, such that the optical zoom setting maximizes a pixel resolution of the see-through window;
receiving data of a zoomed image of the surrounding from the camera, with the optical zoom setting applied to the camera;
computing a second set of cropping parameters, a second set of deforming parameters, or both, based on the first spatial relationship, the second spatial relationship, a viewing angle of the zoomed image, and the dimension of the display; and
applying the second set of cropping parameters, the second set of deforming parameters, or both, to the zoomed image to generate the see-through window.

11. The apparatus of claim 1, further comprising:
the camera; and
the display,
wherein, in presenting the see-through window on the display, the processor is configured to perform operations comprising:
determining a color temperature setting for the see-through window; and
presenting the see-through window on the display with the color temperature setting.

12. The apparatus of claim 11, further comprising:
an ambient light sensor,
wherein, in determining the color temperature setting, the processor is configured to determine the color temperature setting based on either the image of the surrounding or red-green-blue (RGB) data from the ambient light sensor.

13. The apparatus of claim 1, wherein, in presenting the see-through window on the display, the processor is configured to perform operations comprising:
blurring at least a part of the see-through window to create a second visual effect of a substantially single depth of focus of human eyes; and
presenting the see-through window on the display with the second visual effect.

14. The apparatus of claim 1, wherein, in presenting the see-through window on the display, the processor is configured to perform operations comprising:
determining a transparency setting for the see-through window; and
presenting the see-through window on the display with the transparency setting along with one or more other displaying objects, the one or more other displaying objects comprising one or more icons, one or more buttons, one or more graphical user interface (GUI) objects, or one or more augmented reality (AR) objects.

15. A method of simulating a display to be substantially transparent to a user, the method comprising:
capturing a first image of a surrounding of the display with a first camera, the first image having a first viewing angle;
constructing a see-through window of the first image, wherein, when presented on the display, the see-through window substantially matches the surrounding and creates a first visual effect with which at least a portion of the display is substantially transparent to the user;
capturing a second image of the user with a second camera, the second image having a second viewing angle; and
presenting the see-through window on the display.

16. The method of claim 15, wherein the constructing of the see-through window comprises:
determining a first spatial relationship denoting a location of the surrounding with respect to the display;
determining a second spatial relationship denoting a location of the user with respect to the display;
computing a set of cropping parameters, a set of deforming parameters, or a combination of both, based on the first spatial relationship, the second spatial relationship, the first viewing angle, the second viewing angle, and a dimension of the display; and
applying the set of cropping parameters, the set of deforming parameters, or both, to the first image to generate the see-through window.

17. The method of claim 16, wherein:
the determining of the first spatial relationship comprises estimating a first distance using the first camera, the first distance denoting the location of the surrounding with respect to the display, and
the determining of the second spatial relationship comprises estimating a second distance and a set of angles using either or both of the second camera and the second image, the second distance and the set of angles collectively denoting the location of the user with respect to the display.

18. The method of claim 16, wherein each of the first and second cameras is integrated with the display, and wherein the computing of the set of cropping parameters, the set of deforming parameters, or both, is further based on a respective offset between each of the first and second cameras and a center of the display.

19. The method of claim 15, wherein the presenting of the see-through window on the display comprises:
determining a color temperature setting for the see-through window; and
presenting the see-through window on the display with the color temperature setting.

20. The method of claim 15, wherein the presenting of the see-through window on the display comprises:
blurring at least a part of the see-through window to create a second visual effect of a substantially single depth of focus of human eyes; and
presenting the see-through window on the display with the second visual effect.

21. The method of claim 15, wherein the presenting of the see-through window on the display comprises:
determining a transparency setting for the see-through window; and
presenting the see-through window on the display with the transparency setting along with one or more other displaying objects, the one or more other displaying objects comprising one or more icons, one or more buttons, one or more graphical user interface (GUI) objects, or one or more augmented reality (AR) objects.

22. The method of claim 15, further comprising:
adaptively and continually repeating the capturing of the first and second images, the constructing of the see-through window, and the presenting of the see-through window on the display such that the display appears to be substantially transparent to the user in response to a relative movement of any of the user, the display, and the surrounding with respect to any other thereof.
